(19) United States
(12) Patent Application Publication
(10) Pub. No.: US 2012/0076116 A1
(43) Pub. Date: Mar. 29, 2012

(54) MODEM FOR WIRELESS COMMUNICATION

(75) Inventors: Jim O'Connor, Idaho Springs, CO (US); Jake Chou, Greenwood Village, CO (US)

(73) Assignee: Open Range Communications Inc., Greenwood Village, CO (US)

(21) Appl. No.: 12/889,102

(22) Filed: Sep. 23, 2010

(51) Int. Cl. H04W 88/16; H04W 88/02; B23P 6/00; H01Q 1/24

(52) U.S. Cl. 370/338; 343/702; 370/310; 29/592.1

(57) ABSTRACT

A device for wireless communication, for example a WiMAX gateway, may include a control circuit comprising a wireless transceiver, an enclosure enclosing the control circuit, and a pair of antennas for wirelessly communicating with an external device via the wireless transceiver. The antennas may be mechanically coupled to an outside of the enclosure and electrically coupled to the control circuit, and may be collapsible to a stowed configuration to reduce the size of the device when the device is not in operation, and extendable to an operational configuration in which the antennas are spaced apart and are substantially parallel with each other. An interlock may disable operation of the device when the antennas are in the stowed configuration. The device may include a second antenna and transceiver, for example to provide WiFi connectivity.

### BACKGROUND OF THE INVENTION

Some areas, especially sparsely populated areas, are not well served for electronic communications. For example, telephone wiring reaches nearly all households in the United States, but in some areas, the existing wiring may not be suitable for carrying communications other than telephone calls. Residents of these areas therefore need alternative communication methods to receive high-speed Internet access and the like. However, the cost of providing upgraded wiring may be prohibitive. In addition, wired communications systems do not provide for mobile access. Even within a home or other building, wiring may not exist in all areas where communications access is desired.

### BRIEF SUMMARY OF THE INVENTION

Embodiments of the invention relate to gateway devices for wireless communication. For example a gateway device may communicate wirelessly with a base station according to the IEEE 802.16 standards for local and metropolitan networks (which may be implemented as WiMAX communications) and may also provide wired or wireless communications with other devices in the vicinity of the gateway device. One application of such a gateway device, operated in conjunction with a base station, is to provide broadband Internet and other communications at a home or other building in a sparsely populated area. Devices according to embodiments of the invention may include measures to reduce electromagnetic interference, and may be upgradeable to include satellite communications capability.

According to some embodiments, a device for wireless communication includes a control circuit comprising a wireless transceiver, an enclosure enclosing the control circuit, and a pair of antennas for wirelessly communicating with an external device via the wireless transceiver. The antennas are mechanically coupled to an outside of the enclosure and electrically coupled to the control circuit. The pair of antennas is collapsible to a stowed configuration to reduce the size of the device when the device is not in operation, and is extendable to an operational configuration in which the antennas are spaced apart and are substantially parallel with each other. In some embodiments, the device for wireless communication further includes a detent mechanism for each of the antennas, each detent mechanism biasing its respective antenna toward the operational configuration when the antennas are in the operation configuration. The device may further include a sensor that provides a signal indicating when at least one of the antennas is in the stowed configuration, and an antenna interlock responsive to the signal, the antenna interlock disabling operation of the device when the signal indicates that the antennas are in the stowed configuration. In some embodiments, the device may include a sensor that provides a signal indicating whether at least one of the antennas is in the operational configuration, and an antenna interlock responsive to the signal, the antenna interlock disabling operation of the device when the signal indicates that at least one of the antennas is not within a predetermined angular range of the operational configuration.

In some embodiments, the wireless transceiver is a first wireless transceiver and the pair of antennas is a pair of first antennas for wirelessly communicating with a first external device via the first wireless transceiver using a first range of frequencies, and the control circuit further includes a second wireless transceiver and a second antenna for wirelessly communicating with a second external device via the second wireless transceiver using a second range of frequencies. The second wireless transceiver may be a WiFi transceiver. The second antenna may be disposed substantially orthogonal to each of the first antennas when the first antennas are in the operational configuration. In some embodiments, the first antennas can swivel with respect to the enclosure when the first antennas are in the operational configuration, while maintaining their substantially parallel relationship to each other and maintaining their substantially orthogonal relationship to the second antenna. The second antenna may be formed by a trace in a circuit board holding the control circuit. The second antenna may be disposed within a portion of the enclosure substantially as far displaced as possible from the first antennas.

In some embodiments, the antennas can swivel with respect to the enclosure when the antennas are in the operational configuration, while maintaining their substantially parallel relationship to each other. In some embodiments, the control circuit comprises contacts for a jumper not normally accessible to a user of the device, such that when the jumper is in place, power flows from an external supply to the wireless transceiver, and when the jumper is not in place, power is cut off from the wireless transceiver. The device for wireless communication may be a WiMax gateway.

In accordance with other embodiments, a device for wireless communication includes a first control circuit comprising a first wireless transceiver, a second control circuit comprising a second wireless transceiver, and an inter-circuit interlock that disables the first wireless transceiver when power is supplied to the second wireless transceiver. The inter-circuit interlock may disable power to the first wireless transceiver when power is supplied to the second wireless transceiver. The device may further include an enclosure that houses both the first and second control circuits. In some embodiments, the first and second wireless transceivers are configured to communicate with external devices using overlapping sets of frequencies, and the inter-circuit interlock ensures that only one of the wireless transceivers operates at a time. In some embodiments, the device for wireless communication may further include a set of contacts in a power supply line of the first control circuit, a connector connecting the set of contacts to the second control circuit, and a switching device in the second control circuit, wherein the switching device is configured to close the contacts when the second control circuit is inactive by virtue of being unpowered, and wherein the switching device is configured to open the contacts when the second control circuit is powered. The first control circuit may provide the functions of a WiMax gateway, and the second control circuit may provide the functions of a satellite communications gateway.

According to other embodiments, a method of upgrading a gateway device includes the step removing a first circuit board from the gateway device, the first circuit board including a first control circuit that includes a first wireless transceiver and a set of contacts in a power supply line of the first circuit board. The method further includes providing a second circuit board that includes a second control circuit that includes a second wireless transceiver and a connector configured to engage the contacts of the first circuit board, installing both the first and second circuit boards in a common enclosure, and engaging the connector with the contacts. In these embodiments, the second circuit board further includes a switching device in the second control circuit, and the switching device is configured to close the contacts when the second control circuit is inactive by virtue of being unpowered, and the switching device is configured to open the contacts when the second control circuit is powered. In some embodiments, no other electrical connection is made between the first and second circuit boards.

### BRIEF DESCRIPTION OF THE DRAWINGS

FIG. 1 illustrates a system that utilizes communication signals and protocols according to the IEEE 802.16 standards for local and metropolitan networks.

FIG. 2 illustrates a partially cutaway view of a gateway device in accordance with embodiments of the invention.

FIG. 3 illustrates the device of FIG. 2, with antennas in a stowed configuration.

FIG. 4 illustrates one example arrangement of a sensor that can detect when an antenna is in its stowed configuration.

FIG. 5 illustrates a simplified block diagram of a method of disabling operation of the gateway device of FIG. 2 in response to a sensor signal, in accordance with embodiments of the invention.

FIG. 6 illustrates a gateway device in accordance with embodiments of the invention.

FIG. 7 illustrates a rear perspective view of the exemplary gateway device of FIG. 2, showing one possible arrangement of connectors.

FIG. 8A illustrates a gateway device in accordance with other embodiments.

FIG. 8B illustrates the gateway device of FIG. 8B in an alternate orientation.

FIG. 9 illustrates an alternative system for providing wireless communications, in accordance with embodiments of the invention.

FIG. 10A illustrates a feature that may be included in a gateway device such as the gateway device of FIG. 2 or the gateway device of FIG. 8A, facilitating upgradeability of the gateway device to accommodate satellite communications.

FIG. 10B illustrates the connection of a jumper, in accordance with embodiments of the invention.

FIG. 11 shows the gateway device of FIG. 2 in a state of partial disassembly.

FIG. 12 illustrates a replacement bottom cover for the gateway device of FIG. 2.

FIG. 13 illustrates the installation of two circuit boards in the bottom cover of FIG. 12, in accordance with embodiments of the invention.

FIG. 14 shows a rear perspective view of a modified gateway device, in accordance with embodiments of the invention.

FIG. 15 illustrates an example circuit for implementing an inter-circuit interlock function.

### DETAILED DESCRIPTION OF THE INVENTION

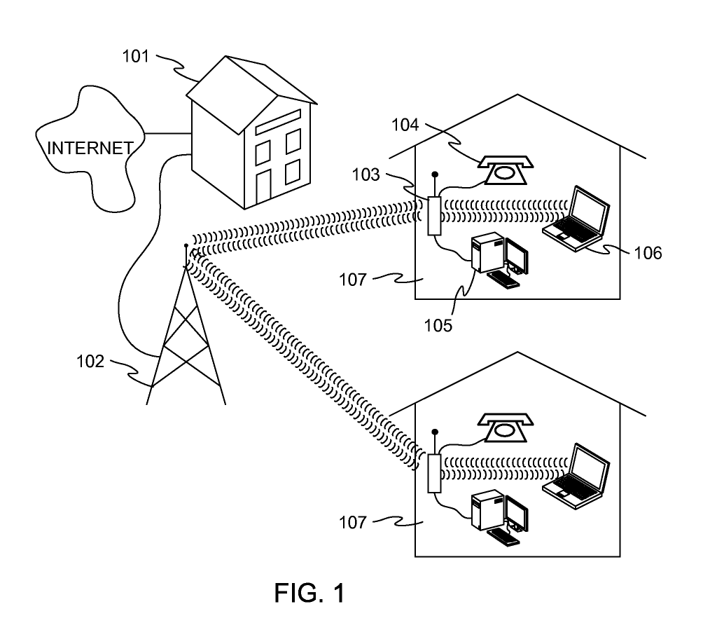

Wireless communication technologies have evolved to fill some gaps in communication coverage. For example, FIG. 1 illustrates a system that utilizes communication signals and protocols according to the IEEE 802.16 standards for local and metropolitan networks. Certain interoperable implementations of the IEEE 802.16 standard are ratified by the WiMAX Forum™, and are generally referred to as “WiMAX™” (Worldwide interoperability for microwave access). Communications according to IEEE 802.16 typically utilize frequencies between 2.485 and 2.495 GHz in the electromagnetic spectrum, and may operate over distances of as much as 30 miles or more.

In the example configuration of FIG. 1, an internet service provider (ISP) 101 operates a base station 102 that can wirelessly communicate bidirectionally with a number of gateway devices 103 within range of base station 102. Each gateway device 103 may in turn communicate via wired or wireless signals with a number of other devices such as a telephone 104, desktop computer 105, or portable computer 106. Many, many other configurations and combinations of devices are possible.

A particular gateway device 103 may include an integrated access point that operates using signals and protocols according to the IEEE 801.11 standards for wireless local area networks. Certain interoperable implementations of the IEEE 802.11 standard are ratified by the WiFi Alliance, and are generally referred to as “WiFi®”. Communications according the IEEE 802.11 typically utilize frequencies allocated in 14 channels between 2.412 and 2.484 GHz in the electromagnetic spectrum, and typically operate over distances of up to about 100 to 400 feet.

The system of FIG. 1 may be used, for example, to provide broadband Internet access and other communications capabilities to homes 107 in sparsely populated areas, although it is to be understood that embodiments of the invention may be used in a variety of other locations and applications as well.

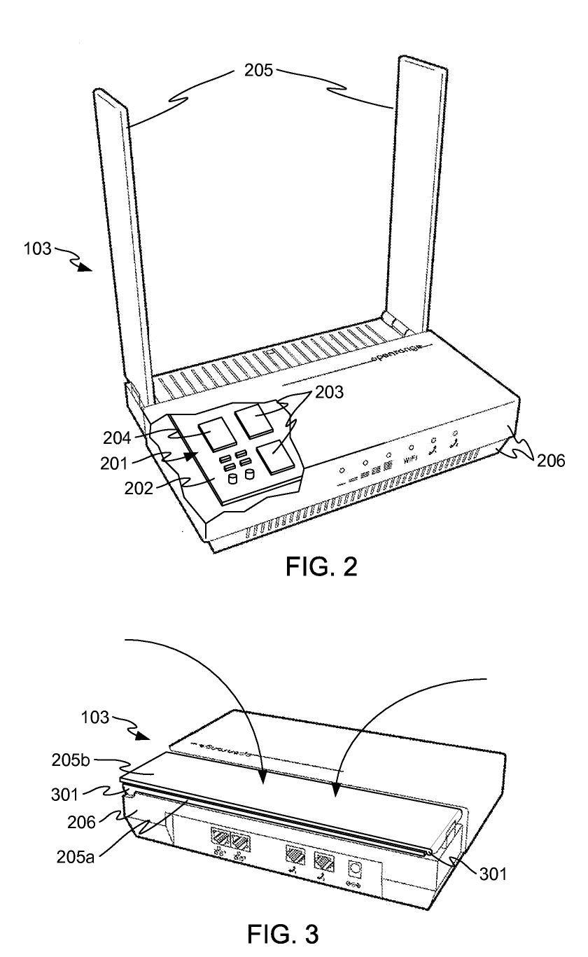

FIG. 2 illustrates a partially cutaway view of a gateway device 103 in accordance with embodiments of the invention. Gateway device 103 includes a control circuit 201, which may be embodied in a printed circuit board 202 holding a number of electronic components 203. Control circuit 201 comprises a wireless transceiver 204 coupled to a pair of antennas 205 for communicating with an external device via wireless transceiver 204. For example, wireless transceiver 204 and antennas 205 may enable wireless communications with base station 102 according to the IEEE 802.16 specification, and gateway device 103 may be a WiMAX gateway. That is, gateway device 103 may serve as a communication gateway between WiMAX base station 102 and other devices in the vicinity of gateway device 103 that communicate via other protocols. An enclosure 206 encloses the control circuit 201. For simplicity of explanation, wireless transceiver 204 will be referred to as a WiMAX transceiver, and printed circuit board 202 will be referred to as a WiMAX circuit board, but it will be understood that the claims are not so limited. While WiMAX circuit board 202 is shown for ease of illustration as a single board, it will be understood that WiMAX circuit board 202 could be implemented using multiple boards or other circuit carriers, for example in a motherboard/daughterboard arrangement.

In FIG. 2, antennas 205 are shown in an operational configuration in which antennas 205 are spaced apart and substantially parallel with each other. This configuration is chosen in part to provide good communications performance for WiMAX transceiver 204. However, for shipping, storage, or transportation of gateway device 103, it may be desirable to reduce its size. Accordingly, antennas 205 are configured to be collapsible into a stowed position, as illustrated in FIG. 3. In the configuration of FIG. 3, which shows gateway device 103 in a rear perspective view, antenna 205a has been rotated downward to lie against enclosure 206, and antenna 205b has been rotated downward to lie against antenna 205a. Each antenna 205 is supplied with a hinge 301.

Gateway device 103 may include a detent mechanism associated with each hinge 301, configured to bias antennas 205 toward either the operational configuration or the stowed configuration. For example, when antennas 205 are stowed, the detent mechanisms may bias antennas 205 against enclosure 106 so that antennas 205 tend to remain in the stowed configuration, but when antennas 205 are in the operational configuration, the detent mechanisms may bias antennas 205 outward, so they tend to remain in the operational configuration.

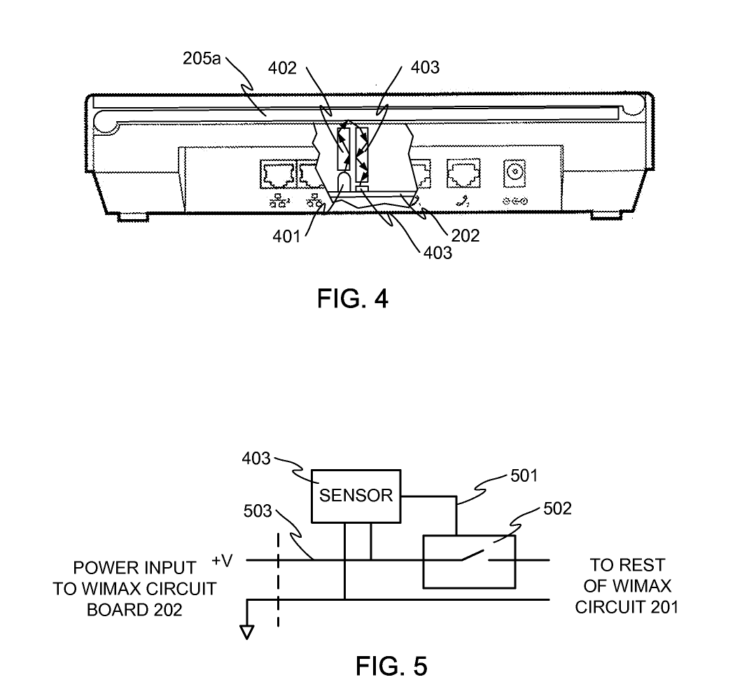

In some embodiments, gateway device 103 may include an antenna interlock that ensures that gateway device 103 will not operate with antennas 205 in or near the stowed configuration. FIG. 4 illustrates one example arrangement of a sensor that can detect when either or both antennas 205a and 205b are in or near the stowed configuration. In this arrangement, a light source, for example a light emitting diode (LED) 401 is mounted on WiMAX circuit board 202, and light from LED 401 is directed toward the location where antennas 205a and 205b would be in the stowed configuration. A light pipe 402 may be utilized to guide light from LED 401. A window or opening may be provided in the top of enclosure 106 to permit the passage of light from LED 401 and to sensor 403. A sensor 403 may be positioned in close proximity to LED 401 on WiMAX circuit board 202, to receive light reflected from antenna 205a or 205b, if any. A second light pipe 404 may be utilized to enhance the collection of reflected light and its direction toward sensor 403.

Sensor 403 produces a signal that indicates when it is receiving light. For example, sensor 403 may comprise a photodiode, photoresistor, phototransistor, or another kind of photosensitive element that changes its behavior upon exposure to light. Sensor 403 may include other circuitry that translates the behavior of the photosensitive element to a usable signal, such as a voltage whose level indicates whether or not sensor 403 is receiving light. This signal may be utilized by an antenna interlock that disables operation of gateway device 103 when an antenna is in or near the stowed configuration.

FIG. 5 illustrates a simplified block diagram of a method of disabling operation of gateway device 103 in response to signal 501 from sensor 403, in accordance with embodiments of the invention. In this embodiment, antenna interlock 502 receives signal 501 and interrupts power line 503 when signal 501 indicates that antenna 205a is in the stowed configuration, but connects power line 503 when signal 501 indicates that antenna 205a is not in the stowed configuration. Antenna interlock 502 may include, for example, a relay, a solid state switch, or another device or set of devices configured to interrupt or connect power line in response to signal 501. Many other techniques for disabling the operation of gateway device 103 are possible. For example, signal 501 could be supplied to a microprocessor included in control circuit 201, and the microprocessor (not shown) may in turn enable or disable portions of control circuit 201 in response to signal 501.

In some embodiments, gateway device 103 may be prevented from operating if antennas 205a and 205b are not at or near their operational configuration. Enforcing operation of gateway device 103 with antennas 205a and 205b fully deployed helps ensure efficient operation of gateway device 103 as described in more detail below, and also facilitates efficient operation of base station 102. For example, gateways device may be prevented from operating if either or both of antennas 205a and 205b are not within a predetermined angular range from the operational configuration. The predetermined angular range may be, for example, 10 degrees, 20 degrees, 30 degrees, or another predetermined angular range.

Operation with antennas 205a and 205b at or near their operational configuration may be enforced by any suitable method. For example, sensor 403 may be able to detect an antenna some distance away from enclosure 106, so that operation of gateway device 103 is disabled if antennas 205a and 205b are not at or near their operational configuration. The detent mechanisms associated with antennas 205a and 205b may also assist in enforcing proper deployment of antennas 205a and 205b. For example, if antennas 205a and 205b are rotated only a small distance away from enclosure 106, the detent mechanism may prevent the antennas from remaining in that position, and may force the antennas against enclosure 106 so that antenna interlock 502 is activated. Similarly, if antennas 205a and 205b are rotated significantly but not entirely toward the operational configuration, the detent mechanisms may force the antennas outward to the fully deployed operational configuration.

Other kinds of sensors and mechanisms could be used as well. For example, either or both of antennas 205a and 205b may be monitored by a limit switch, and optical interrupter, a capacitance probe, a magnetic sensor, or another suitable kind of sensor that produces a signal that can be used to activate antenna interlock 502 when antennas 205a and 205b are not properly deployed. For example, a sensor could detect whether antennas 205a and 205b are in their operational configuration, and produce a signal activating antenna interlock 502 when either or both antennas depart from the operational configuration.

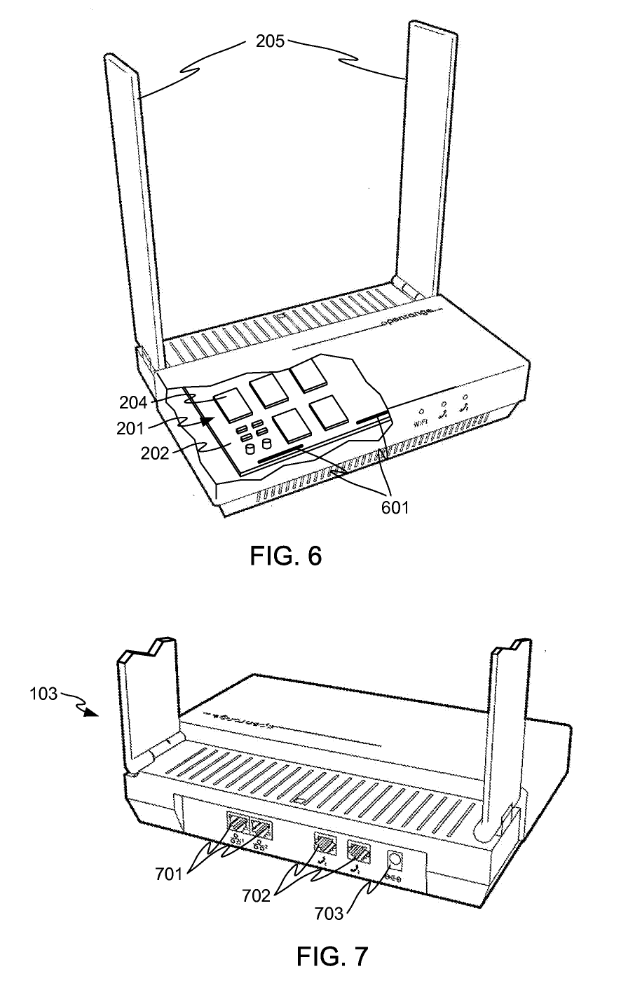

In some embodiments, gateway device 103 may include a second wireless transceiver and at least one second antenna (separate from the pair of first antennas 205), for example as part of an integrated access point that communicates with other external devices according to IEEE 802.11 specifications. Such an access point may provide WiFi wireless connectivity with devices such as portable computers in the vicinity of gateway device 103. FIG. 6 illustrates a gateway device 103 in accordance with this embodiment. In this example, two second antennas 601 are provided, and are formed as traces in WiMAX circuit board 202. Alternatively, one or more separate antennas could be provided. Also shown in FIG. 6 is second wireless transceiver 602 comprised in control circuit 201. Wireless transceiver 602 may be referred to as a WiFi transceiver.

Because communications according to IEEE 802.16 and IEEE 802.11 may utilize frequencies that are very close to each other along the electromagnetic spectrum, various measures may be implemented in gateway device 103 to minimize interference between the two transceivers. One measure, illustrated in FIG. 6, is that second antennas 601 are placed within enclosure 106 at a location substantially as far displaced from first antennas 205 as possible. In the example of FIG. 6, second antennas 601 are placed at the extreme front edge 602 of WiMAX circuit board 202, while first antennas 205 are near the back edge 603 of enclosure 106.

Additionally, control circuit 201 may implement filtering techniques that reduce the likelihood of interference between the two transceivers.

Another interference-reducing measure is implemented in the embodiment shown in FIG. 6. Antennas 205 in their operational configuration are substantially orthogonal to antennas 601, further reducing the likelihood or strength of any interference between the two wireless transceivers. Antenna interlock 502 may help to enforce this orthogonality, preventing operation of gateway device 103 when antennas 205 are in their stowed configuration.

In yet another measure to reduce the likelihood of detrimental interference, the WiFi transceiver 602 may be restricted from using otherwise-available channels that are especially close in frequency to frequencies used by WiMAX transceiver 204. For example, in the United States, it is common for devices implementing IEEE 802.11 communications to utilize any of channels 1, 6, and 11, centered at 2.412, 2.437, and 2.462 GHz respectively. Gateway device 103 may be configured to prevent operation using channel 11, the closest of the three commonly-used IEEE 802.11 channels to the frequencies utilized by IEEE 802.16 devices.

FIG. 7 illustrates a rear perspective view of exemplary gateway device 103, showing one possible arrangement of connectors that may be provided. A power input connector 701 may receive electrical power in any suitable form. For example, direct current (DC) power may be supplied from an external transformer (not shown) plugged into the electrical mains. Alternatively, gateway device 103 may be configured to receiver alternating current (AC) power. One or more telephone connectors 702 may be provided, for connecting one or more telephones. In some embodiments, gateway device 103 provides “voice over Internet protocol” (VOIP) telephone capability. Telephone connectors 702 may be, for example, type RJ11 telephone jacks, or another suitable kind of connector. One or more data network connectors 703 may also be provided, for example for making wired connections to computer equipment. Data network connectors 703 may be, for example, the kind of connectors typically referred to as type RJ45 Ethernet jacks, or another suitable kind of connector Many other combinations of connections are possible.

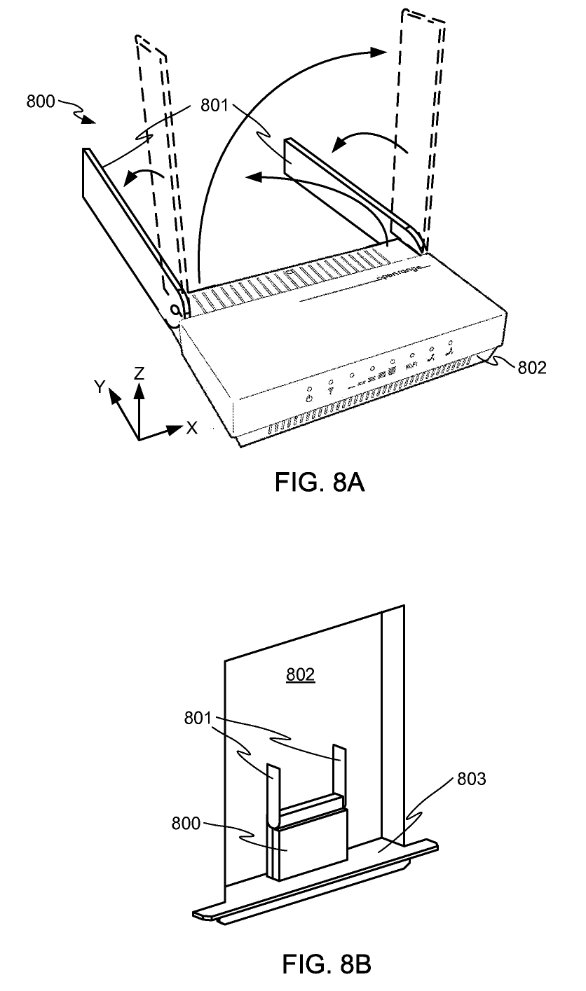

FIG. 8A illustrates a gateway device 800 in accordance with other embodiments. Gateway device 800 includes an additional degree of freedom in the positioning of antennas 801. In addition to rotations about axes parallel to the Y axis illustrated in FIG. 8A for raising antennas 801 to their operational configuration, antennas 801 can also rotate, individually or as a unit, about an axis parallel to the X axis illustrated in FIG. 8A. This additional degree of freedom provides additional options for the placement of gateway device 800 for the reception of signals by antennas 801. For example, it may be desirable that antennas 801 be positioned vertically for best reception, and that gateway device 800 be placed near a window so as to encounter the least obstruction signals coming from a base station such as base station 102. The configurability of antennas 801 may enable gateway device 800 to be used in the orientation illustrated in FIG. 8B, with both the enclosure of gateway device 800 and antennas 801 being in a vertical orientation. In FIG. 8B, gateway device 800 is placed in a window 802 on windowsill 803.

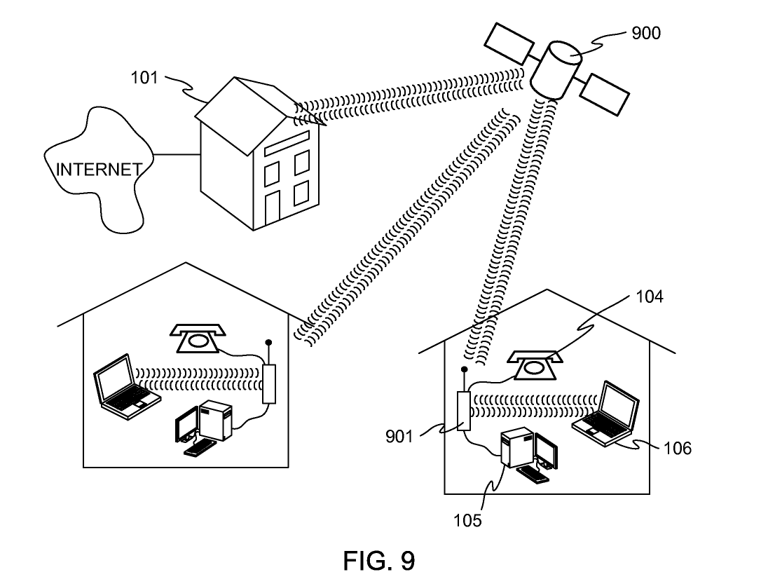

FIG. 9 illustrates an alternative system for providing wireless communications, in accordance with embodiments of the invention. The arrangement of FIG. 9 is similar to the arrangement of FIG. 1, except that ISP 101 uses a satellite 900 rather than terrestrial base station 102. ISP 101 communicates bidirectionally with satellite 900, which in turn communicates with various gateway devices 901. Satellite 900 may, for example, be in geosynchronous orbit or may be one of a constellation of satellites in low or medium altitude orbits around the Earth.

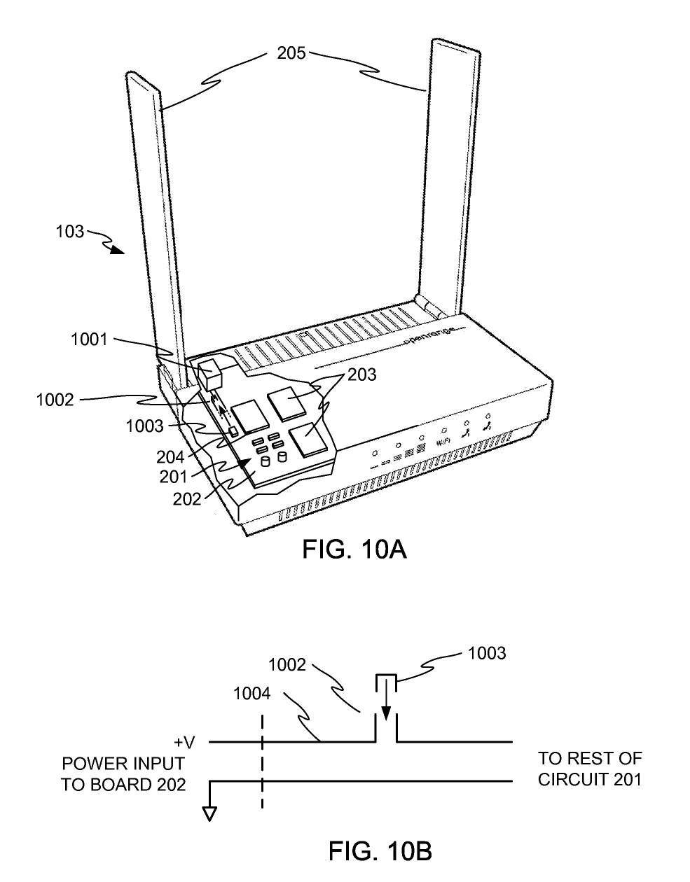

In some cases, it may be desirable that a gateway device such as gateway device 103 be upgradeable to accommodate satellite communications as well as communications according to IEEE 802.16. Once upgraded, gateway device 103 may also serve as a satellite gateway, serving as a communication gateway between satellite 900 and other devices in the vicinity of gateway device 103 that communicate via other protocols. FIG. 10A illustrates a feature that may be included in a gateway device such as gateway device 103 or gateway device 800, facilitating upgradeability of the gateway device to accommodate satellite communications. Just inboard of power connector 1001 through which exemplary gateway device 103 receives power, connections 1002 for a jumper 1003 are provided. The connections are shown schematically in FIG. 10B. In normal operation without satellite capability, a jumper 1003 is provided, bridging the connections so that power line 1004 is uninterrupted, and power flows to the rest of control circuit 201, including WiMAX transceiver 204. Jumper 1003 may not normally be accessible to a user of gateway device 103, but if jumper 1002 were to be removed, power would be cut off from the rest of control circuit 201, including WiMAX transceiver 204.

This jumper arrangement may be used in the process of upgrading gateway device 103. Because satellite communications may use frequencies that overlap with frequencies utilized by communications according to IEEE 802.16, upgraded gateway device 103 may be configured so that it is not possible for WiMAX transceiver 204 and any wireless transceiver used for satellite communications can operate at the same time.

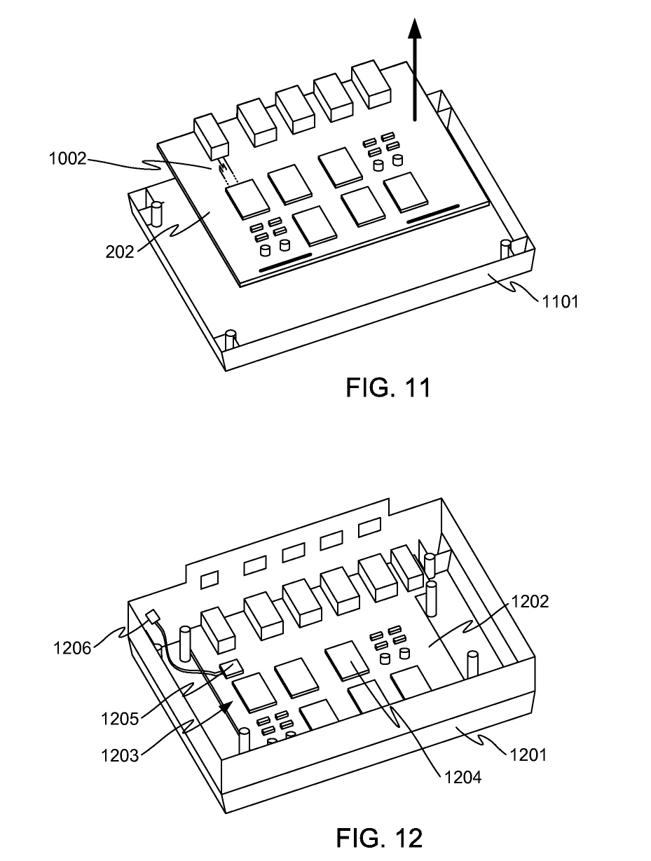

FIGS. 11-14 illustrate a technique for upgrading gateway device 103 to include the capability to communicate with a satellite such as satellite 900. In FIG. 11, gateway device 103 has been disassembled, and WiMAX circuit board 202 loosened from bottom cover 1101. Antennas 205 and their connections to WiMAX circuit board 202 are not shown in FIG. 11, but they may be removed from bottom cover 1101 along with WiMAX circuit board 202, and may remain connected to WiMAX circuit board 202 throughout the upgrade process. Jumper 1003 has also been removed from contacts 1002.

In FIG. 12, a replacement bottom cover 1201 and a second circuit board 1202 are provided. Circuit board 1202 comprises a second control circuit 1203 having a second transceiver 1204 that communicates with satellite 900 through an external antenna (not shown). For simplicity of explanation, second transceiver 1204 will be referred to as a satellite transceiver, and second circuit board 1202 will be referred to as a satellite circuit board. While satellite circuit board 1202 is shown for ease of illustration as a single board, it will be understood that satellite circuit board 1202 could be implemented using multiple boards or other circuit carriers, for example in a motherboard/daughterboard arrangement. Second control circuit 1203 also includes a switching device 1205 and a connector 1206 coupled to switching device 1205. Switching device 1205 may be used to provide an inter-circuit interlock, as is described in more detail below.

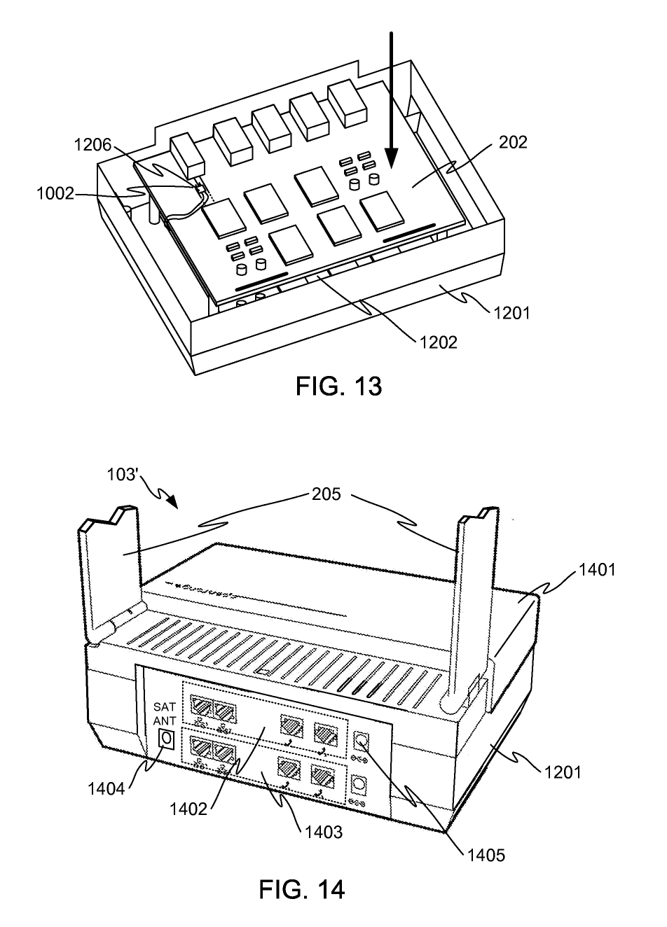

Replacement bottom cover 1201 is deeper than bottom cover 1101, and has room for WiMAX circuit board 202 in addition to satellite circuit board 1202. FIG. 13 illustrates that WiMAX circuit board 202 can be installed within bottom cover 1201, over satellite circuit board 1202. Connector 1206 is engaged with contacts 1002, making a connection between satellite circuit board 1202 and WiMAX circuit board 202. In some embodiments, this may be the only electrical connection between WiMAX circuit board 202 and satellite circuit board 1202. Antennas 205 may then be reconnected (if necessary) to WiMAX circuit board 202 and assembled onto bottom cover 1201.

FIG. 14 shows a rear perspective view of the modified gateway device 103′ once antennas 205 and top cover 1401 are in place. A user may now use gateway device 103′ either for communications via antennas 205 to a terrestrial base station such as base station 102, or for communications via an external antenna to a satellite such as satellite 900. Preferably, the user connects any computers and telephones to connector set 1402 (of WiMAX circuit board 202) for communications through antennas 205, and connects the computers and telephones to connector set 1403 (of satellite circuit board 1202) to utilize satellite communications. An external satellite antenna is preferably connected to satellite antenna connector 1404.

Because of the overlap in frequencies used by the two control circuits, switching device 1205 ensures that WiMAX transceiver 204 and satellite transceiver 1204 cannot be used at the same time. In one example embodiment, whenever power is applied to satellite circuit board 1202, power to WiMAX transceiver 204 is disabled, even if power is supplied to power connector 1405.

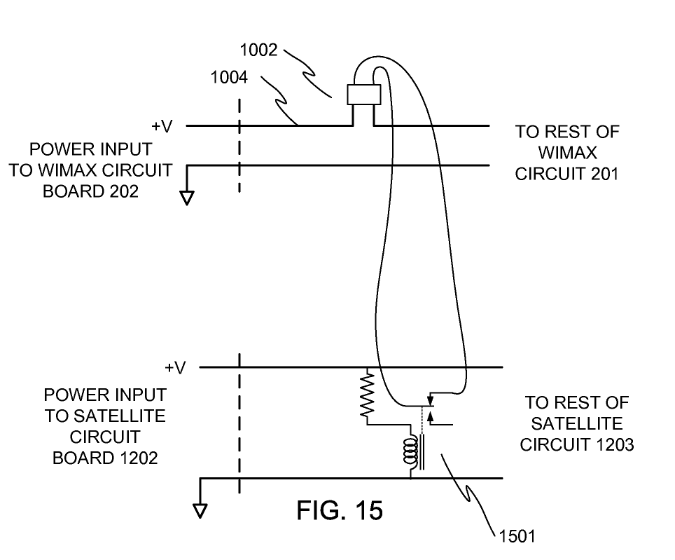

FIG. 15 illustrates an example circuit for implementing this inter-circuit interlock function. As shown in FIG. 15, connector 1206 engages contacts 1002 on WiMAX circuit board 202, and is also connected to switching device 1205 resident on satellite circuit board 1202. In this example, switching device 1205 comprises a relay 1501, and the connections from contacts 1002 are made to the normally closed contacts of relay 1501. If no power is supplied to satellite circuit board 1202, the relay contacts remain closed, and WiMAX circuit board 202 remains fully powered. Once power is applied to satellite circuit board 1202, the contacts of relay 1501 open, interrupting power to WiMAX circuit board 202, and consequently to WiMAX transceiver 204. Thus, only one of WiMAX transceiver 204 and satellite transceiver 1204 can be used at any one time.

Other kinds of inter-circuit interlocks could also be utilized. For example, a solid state device could be used rather than relay 1501, or WiMAX circuit board 202 could be signaled in some other way the satellite circuit board 1202 is in operation, and WiMAX circuit board 202 could suspend any wireless communication under the control of a microprocessor. Many other techniques are possible.

While the upgrading process and inter-circuit interlock is illustrated above in the context of a wireless gateway device, it is to be understood that similar techniques could be used in other devices, for example a mobile wireless router. A mobile wireless router is a mobile device that can make a wireless connection to the Internet, for example via a cellular telephone network, and also provide wireless connectivity, for example WiFi connectivity, to other devices in the vicinity. Techniques in accordance with embodiments of the invention could be used to upgrade a mobile wireless router to include satellite communications capability, for example. Other devices used in other embodiments may have significantly different form factors than illustrated in FIGS. 11-14. For example, a mobile wireless router may be comparable is size to a handheld device.

The invention has now been described in detail for the purposes of clarity and understanding. However, those skilled in the art will appreciate that certain changes and modifications may be practiced within the scope of the appended claims.

What is claimed is:

1. A device for wireless communication, the device comprising:
a control circuit comprising a wireless transceiver;
an enclosure enclosing the control circuit; and
a pair of antennas for wirelessly communicating with an external device via the wireless transceiver, the antennas mechanically coupled to an outside of the enclosure and electrically coupled to the control circuit;
wherein the pair of antennas is collapsible to a stowed configuration to reduce the size of the device when the device is not in operation;
and wherein the pair of antennas is extendable to an operational configuration in which the antennas are spaced apart and are substantially parallel with each other.

2. The device for wireless communication of claim 1, further comprising a detent mechanism for each of the antennas, each detent mechanism biasing its respective antenna toward the operational configuration when the antennas are in the operation configuration.

3. The device for wireless communication of claim 1, further comprising:
a sensor that provides a signal indicating when at least one of the antennas is in the stowed configuration; and
an antenna interlock responsive to the signal, the antenna interlock disabling operation of the device when the signal indicates that the antennas are in the stowed configuration.

4. The device for wireless communication of claim 1, further comprising:
a sensor that provides a signal indicating whether at least one of the antennas is in the operational configuration; and
an antenna interlock responsive to the signal, the antenna interlock disabling operation of the device when the signal indicates that at least one of the antennas is not within a predetermined angular range of the operational configuration.

5. The device for wireless communication of claim 1, wherein the wireless transceiver is a first wireless transceiver and the pair of antennas is a pair of first antennas for wirelessly communicating with a first external device via the first wireless transceiver using a first range of frequencies, the control circuit further comprising:
a second wireless transceiver; and
a second antenna for wirelessly communicating with a second external device via the second wireless transceiver using a second range of frequencies.

6. The device for wireless communication of claim 5, wherein the second wireless transceiver is a WiFi transceiver.

7. The device for wireless communication of claim 5, wherein the second antenna is disposed substantially orthogonal to each of the first antennas when the first antennas are in the operational configuration.

8. The device for wireless communication of claim 7, wherein the first antennas can swivel with respect to the enclosure when the first antennas are in the operational configuration, while maintaining their substantially parallel relationship to each other and maintaining their substantially orthogonal relationship to the second antenna.

9. The device for wireless communication of claim 7, wherein the second antenna is formed by a trace in a circuit board holding the control circuit.

10. The device for wireless communication of claim 5, wherein the second antenna is disposed within a portion of the enclosure substantially as far displaced as possible from the first antennas.

11. The device for wireless communication of claim 1, wherein the antennas can swivel with respect to the enclosure when the antennas are in the operational configuration, while maintaining their substantially parallel relationship to each other.

12. The device for wireless communication of claim 1, wherein the control circuit comprises contacts for a jumper not normally accessible to a user of the device, such that when the jumper is in place, power flows from an external supply to the wireless transceiver, and when the jumper is not in place, power is cut off from the wireless transceiver.

13. The device for wireless communication of claim 1, wherein the device is a WiMax gateway.

14. A device for wireless communication, the device comprising:
a first control circuit comprising a first wireless transceiver;
a second control circuit comprising a second wireless transceiver; and
an inter-circuit interlock that disables the first wireless transceiver when power is supplied to the second wireless transceiver.

15. The device for wireless communication of claim 13, wherein the inter-circuit interlock disables power to the first wireless transceiver when power is supplied to the second wireless transceiver.

16. The device for wireless communication of claim 14, further comprising an enclosure that houses both the first and second control circuits.

17. The device for wireless communication of claim 14, wherein the first and second wireless transceivers are configured to communicate with external devices using overlapping sets of frequencies, and wherein the inter-circuit interlock ensures that only one of the wireless transceivers operates at a time.

18. The device for wireless communication of claim 14, further comprising:
a set of contacts in a power supply line of the first control circuit;
a connector connecting the set of contacts to the second control circuit; and
a switching device in the second control circuit, wherein the switching device is configured to close the contacts when the second control circuit is inactive by virtue of being unpowered, and wherein the switching device is configured to open the contacts when the second control circuit is powered.

19. The device for wireless communication of claim 14, wherein the first control circuit provides the functions of a WiMax gateway, and the second control circuit provides the functions of a satellite communications gateway.

20. The device for wireless communication of claim 14, wherein the device is a mobile wireless router.

21. A method of upgrading a wireless communication device, the method comprising:
removing a first circuit board from the wireless communication device, the first circuit board including a first control circuit that includes a first wireless transceiver and a set of contacts in a power supply line of the first circuit board;
providing a second circuit board that includes a second control circuit that includes a second wireless transceiver and a connector configured to engage the contacts of the first circuit board;
installing both the first and second circuit boards in a common enclosure; and
engaging the connector with the contacts;
wherein the second circuit board further includes a switching device in the second control circuit, wherein the switching device is configured to close the contacts when the second control circuit is inactive by virtue of being unpowered, and wherein the switching device is configured to open the contacts when the second control circuit is powered.

22. The method of upgrading a wireless communication device of claim 21, wherein no other electrical connection is made between the first and second circuit boards.
